(19) United States
(12) Patent Application Publication
(10) Pub. No.: US 2012/0056059 A1
(43) Pub. Date: Mar. 8, 2012

(54) METHOD AND APPARATUS FOR TELEMETRY DEVICE INSTALLATION

(75) Inventors: Jeffrey L. Delamater, Liberty Lake, WA (US); David C. Shoptaw, Newport, WA (US)

(73) Assignee: ITRON, INC., Liberty Lake, WA (US)

(21) Appl. No.: 12/877,477

(22) Filed: Sep. 8, 2010

(51) Int. Cl. F16M 13/00; B23P 11/00

(52) U.S. Cl. 248/299.1; 248/274.1; 29/428

(57) ABSTRACT

An installation system and device, and an installation method, are provided for installing a telemetry device on a mount surface. In general, the installation system includes a telemetry device and an installation device. The installation device includes a mounting bracket, at least one attachment device, a mounting device, and at least one orientation device. The attachment device may be configured to mount the mounting device to the mount surface. The mounting device may include a mounting plate and a mating aperture for mounting the telemetry device to the mounting bracket. The orientation device may be associated with any one of a plurality of orientation apertures defined in the mounting device to secure the telemetry device to the mounting bracket and to fix an orientation of the telemetry device.

### FIELD OF THE INVENTION

The present subject matter relates generally to telemetry devices, such as cell control units. More specifically, the present subject matter relates to methods and apparatus for installing telemetry devices at desired orientations.

### BACKGROUND OF THE INVENTION

Telemetry devices are widely used in the metering arts to provide remote collection and reporting of data. For example, cell control units (“CCU's”) are examples of telemetry devices. CCU's are widely utilized in the metering arts to report, for example, the amount of gas flowing through gas lines. Presently known CCU's are designed to remotely collect and report, for example, energy consumption data, outage notification data, interval data, and tamper data from endpoints, such as gas meter endpoints.

Telemetry devices must generally be installed in locations that provide adequate coverage, and that allow remote transmission of data to the telemetry devices from a sufficient number of sources. In many cases, the telemetry devices may be mounted to, for example, utility poles or street lights in order to be provided with adequate coverage. Further, many telemetry devices require installation at certain orientations in order to properly function.

Current methods and apparatus for installing telemetry devices require the installer to simultaneously mount and orient the telemetry devices. For example, some methods and apparatus require the installer to install a telemetry device on a pole or post by bolting or strapping the telemetry device directly to the pole or post while simultaneously leveling the telemetry device in one or more planes. Such installation procedures may be both difficult and time-consuming to complete, contributing to inefficient and potentially substandard installations.

Thus, methods and apparatus for installing telemetry devices that facilitate relatively simple and efficient yet desired mounting of the telemetry devices would be desirable in the art. Further, methods and apparatus for installing telemetry devices that allow orienting of the telemetry devices independently of mounting the telemetry devices would be advantageous.

### SUMMARY OF THE INVENTION

Aspects and advantages of the present subject matter are set forth in part in the following description, or may be apparent from the description, or may be learned through practice of the present subject matter.

The present disclosure recognizes and addresses the above-noted drawbacks and disadvantages of typical prior art methods and apparatus for installing telemetry devices.

It is a general object of the present disclosure to provide improved methodology and apparatus for installing a telemetry device. It is a more specific object of the present disclosure to provide method and apparatus that facilitate relatively simple and efficient mounting of a telemetry device, while still allowing orientation of the telemetry device independently of the mounting of the telemetry device. It is another present object to also facilitate servicing of previously installed telemetry devices, such as when a previously installed telemetry device has failed and requires replacement.

Thus, one exemplary embodiment in accordance with the present disclosure relates to an installation system including an installation device and a telemetry device. Such installation system and device may permit installation of the telemetry device on a mount surface, such as on a beam, a pole, a wall, or another suitable surface. An exemplary installation device may include a mounting bracket, at least one attachment device, a mounting device, and at least one orientation device. Such an exemplary attachment device may be configured to mount the mounting device to the mount surface. Further, the mounting device may, in some embodiments, be oriented in at least one plane.

Another present exemplary mounting device may include a mounting plate and a mating aperture for mounting the telemetry device to the mounting bracket. The orientation device may be associated with any one of a plurality of orientation apertures defined in the mounting device so as to secure the telemetry device to the mounting bracket and to fix an orientation of the telemetry device.

Thus, utilizing an exemplary installation system and device of the present disclosure, an installer of a telemetry device may, in an exemplary embodiment, be permitted in accordance with the present disclosure to mount and independently orient the telemetry device on a mount surface. For example, installing the telemetry device on a mount surface may include securing a mounting bracket to a mount surface. Installing the telemetry device may further include mounting the telemetry device to the mounting bracket.

Further, installing the telemetry device of the present disclosure may for some embodiments and/or uses thereof include orienting the telemetry device in at least one plane. For example, a telemetry device, after being mounted to the mounting bracket, may be rotatable with respect to the mounting bracket. Such rotation may allow the telemetry device to be leveled in, for example, either of the Y-Z plane or X-Z plane. To accomplish orientation of the telemetry device, the installer may, after mounting the telemetry device, rotate the telemetry device with respect to the mounting bracket to level the telemetry device.

Installing the telemetry device in accordance with certain embodiments of the present disclosure may further include fixing the orientation of the telemetry device and securing the telemetry device to the mounting bracket.

Thus, the installation system and device of the present disclosure facilitate the relatively simple and efficient mounting of a telemetry device on a mount surface, and further advantageously allow orienting of the telemetry device independently of mounting the telemetry device.

In those instances where the present subject matter is practiced in conjunction with replacement of a failed, previously installed telemetry device, it is to be understood that such failed device can readily be removed and replaced without the necessity of removing the present subject matter mounting plate and attachment. All such subject matter, and uses of the present subject matter, are intended to be encompassed by the present disclosure.

It is to be further understood by those of ordinary skill in the art that the present subject matter equally relates to system and device subject matter as well as to corresponding and/or associated methodology for practice of same.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the present subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents including combinations of features, parts, or steps or configurations thereof not expressly shown in the figures or stated in the detailed description of such figures. Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification. The accompanying drawings, which are incorporated in and constitute a part of this specification, illustrate embodiments of the present subject matter and, together with the description, serve to explain the principles of the present subject matter.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is an exploded perspective view of one present exemplary embodiment of an exemplary installation system in accordance with the present disclosure;

FIG. 2 is a relatively enlarged perspective view of one present exemplary embodiment of an exemplary installation system in accordance with the present disclosure;

FIG. 3 is an exploded perspective view of another present exemplary embodiment of an exemplary installation system in accordance with the present disclosure;

FIG. 4 is an exploded perspective view of yet another present exemplary embodiment of an exemplary installation system in accordance with the present disclosure; and

FIG. 5 is a perspective view of yet another present exemplary embodiment of an exemplary installation system in accordance with the present disclosure.

### DETAILED DESCRIPTION OF THE PREFERRED EMBODIMENTS

Reference is made herein in detail to exemplary embodiments of the present subject matter, one or more examples of which are illustrated and/or represented in the subject drawings. Each example is provided by way of explanation of the present subject matter, not limitation of the present subject matter. In fact, it will be apparent to those skilled in the art that various modifications and variations can be made in and to the present subject matter without departing from the scope or spirit of the present subject matter. For instance, features illustrated or described as part of one embodiment may be used with another embodiment to yield a still further embodiment. Thus, it is intended that the present subject matter covers such modifications and variations as come within the scope of the disclosure and equivalents thereof.

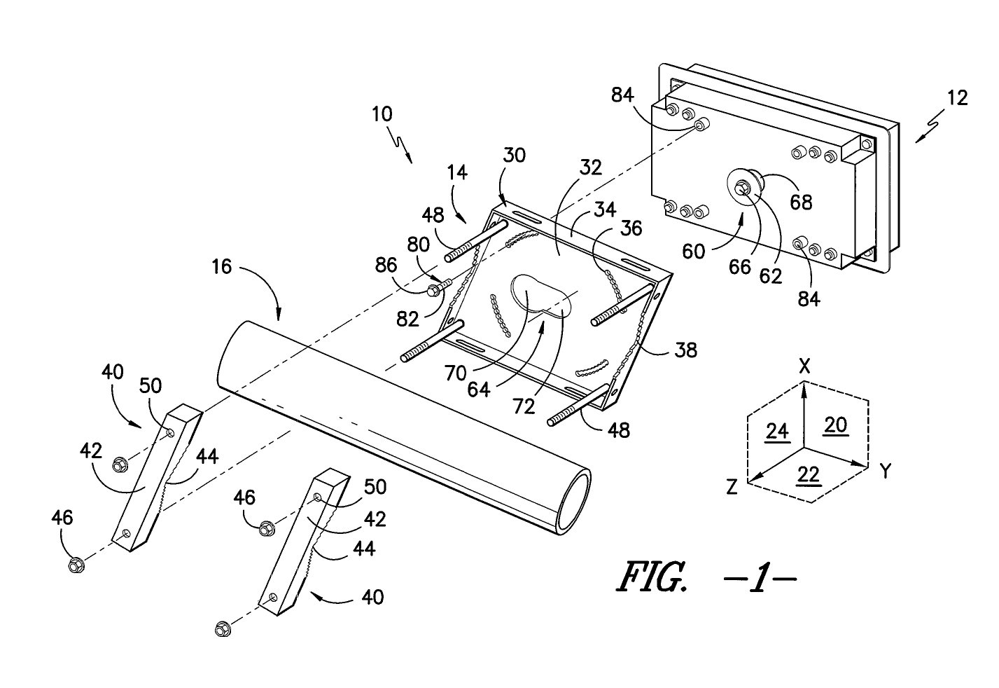

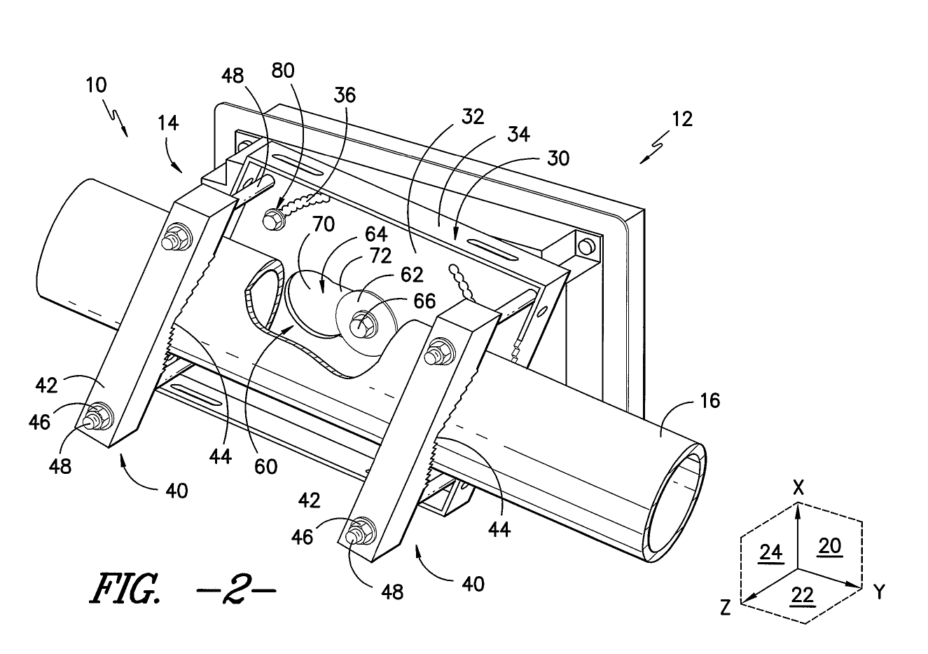

FIGS. 1 through 5 represent and/or illustrate exemplary embodiments of an installation system generally 10 of the present disclosure. The installation system 10 may include a representative telemetry device 12 and an exemplary installation device 14, and may permit installation of the telemetry device 12 on a mount surface 16.

The telemetry device 12 of the present disclosure may, in general, be any device that is configured to provide remote collection and reporting of data. In exemplary embodiments, the telemetry device 12 of the present disclosure may be a cell control unit (“CCU”). The CCU may, for example, be configured to report the amount of gas flowing through gas lines (not shown). Further, the CCU may remotely collect and report energy consumption data, outage notification data, interval data, and tamper data from endpoints (not shown), such as gas meter endpoints, connected to the gas lines.

The telemetry device 12 of the present disclosure may be installed on a mount surface 16. The mount surface 16 may be, for example, a telephone pole, a utility pole, a street lamp, or any other suitable beam or pole, or may be, for example, a wall or other suitable surface.

In exemplary embodiments, the telemetry device 12 of the present disclosure, in order to property function, may require orienting about various axes and in various planes. For example, FIGS. 1 through 5 illustrate a three-dimensional coordinate system with X, Y and Z axes. As is understood in the art, the various axes define various planes. For example, the X and Y axes may define an X-Y plane, labeled as reference numeral 20, while the Y and Z axes define a Y-Z plane 22 and the X and Z axes define an X-Z plane 24. The telemetry device 12 of the present disclosure may require orienting in any one of these planes, such that, for example, the telemetry device 12 is level in the selected one of such planes.

Thus, the installation system 10 of the present disclosure includes an installation device 14 for installing a telemetry device 12 on a mount surface 16. The installation device 14, and thus the installation system 10, of the present disclosure may advantageously allow an installer of the telemetry device 12 to simply and efficiently mount and separately orient the telemetry device 12, and may further beneficially allow orientation of the telemetry device 12 independently of mounting the telemetry device 12.

The installation device 14 of the present disclosure may include, for example, a mounting bracket 30. The mounting bracket 30 may be configured to be secured to the mount surface 16. In general, the mounting bracket 30 may include a main surface 32, and may further include a peripheral wall 34 extending from the main surface 32. The main surface 32 may be, for example, square or rectangular, oval or circular, or may have any other suitable polygonal shape. The mounting bracket 30, such as the main surface 32, may define a plurality of orienting apertures 36. As discussed below, the orienting apertures 36 may be provided to secure and fix the orientation of the telemetry device 12. In some embodiments, the orienting apertures 36 may be defined in groups, such as in two, three, four, or more groups of orienting apertures 36. For example, FIGS. 1 though 5 illustrate four groups of orienting apertures 36 defined in a generally annular array about the main surface 32. It should be understood, however, that more generally in accordance with the present subject matter, the orienting apertures 36 may be defined in the main surface 32 in any suitable pattern to orient and secure the telemetry device 12.

Those of ordinary skill in the art will appreciate from the complete disclosure herewith that present FIGS. 1 through 5 illustrate orienting apertures 36 as collectively being “slot-like” due to individual holes having some degree of overlapping diameters. However, the present FIGS. represent, and the present subject matter encompasses more generally, the use of individual holes, including those which do not have overlapping diameters, so in fact no “slot-like” appearance exists in such instances. In some present alternative instances, full slots with no appearance of individual holes may be practiced. Regardless of the nature of the orienting apertures 36, it is also to be understood by those of ordinary skill in the art from the complete disclosure herewith that more or less angularity of positioning for installers may be provided by extending or restricting, respectively, the length of “slots” and/or the number of individual holes, along the curved placement of orienting apertures 36 generally represented in the present FIGS. All such variations and combinations of different forms, numbers, and placements of orienting apertures 36, and of permitted degrees of adjustment, are intended to come within the spirit and scope of the present subject matter.

The mounting bracket 30, such as at the peripheral wall 34 thereof, may define a notch 38 or plurality of such notches 38. The notches 38 may, for example, allow the mounting bracket 30 to fit against the mount surface 16, as will be understood by those of ordinary skill in the art from the complete disclosure herewith. For example, in some embodiments, the notches 38 may generally have a V-shape, as shown in FIGS. 1 through 5, or a U-shape or any other suitable shape. Further, in some embodiments, the notches 38 may be generally opposed relative to each other on the mounting bracket 30. For example, in exemplary embodiments, the peripheral wall 34 may be a generally square or rectangular wall, and the notches 38 may be defined on opposing sides of the peripheral wall 34, or other, equivalent arrangements may be practiced in accordance with the present disclosure.

The installation device 14 of the present disclosure may further include at least one attachment device 40, or in some embodiments a plurality of attachment devices 40 may be used. The attachment device(s) 40 may be configured to secure the mounting bracket 30 to the mount surface 16. For example, in one exemplary embodiment as shown in FIGS. 1 through 3, an attachment device 40 may include an attachment bar 42. The attachment bar 42 may include a notch 44 to allow the attachment bar 42 to fit against the mount surface 16. The notch may be, for example, V-shaped, U-shaped, or any other suitable shape.

Further, the attachment device 40 may include a nut 46 and bolt 48 or a plurality of nuts 46 and bolts 48. The bolts 48 may be associated with the mounting bracket 30, as shown in FIGS. 1 through 3. Further, the attachment bar 42 may define an aperture 50 or a plurality of apertures 50 configured to accept, respectively, the bolts 48. The nuts 46 may be threadably attached to the ends of the bolts 48 extending through the apertures 50 to secure the mounting bracket 30 and the attachment device 40 together, thus securing the mounting bracket 30 to the mount surface 16. Alternatively, in accordance with the present subject matter, the bolts 48 may be associated with the attachment bar 42 and the mounting bracket 30 may define the apertures 50.

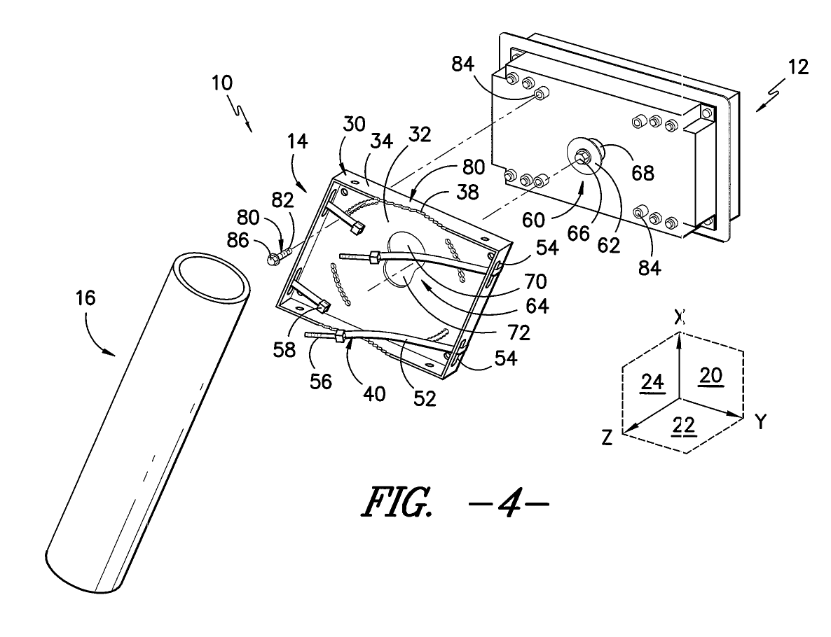

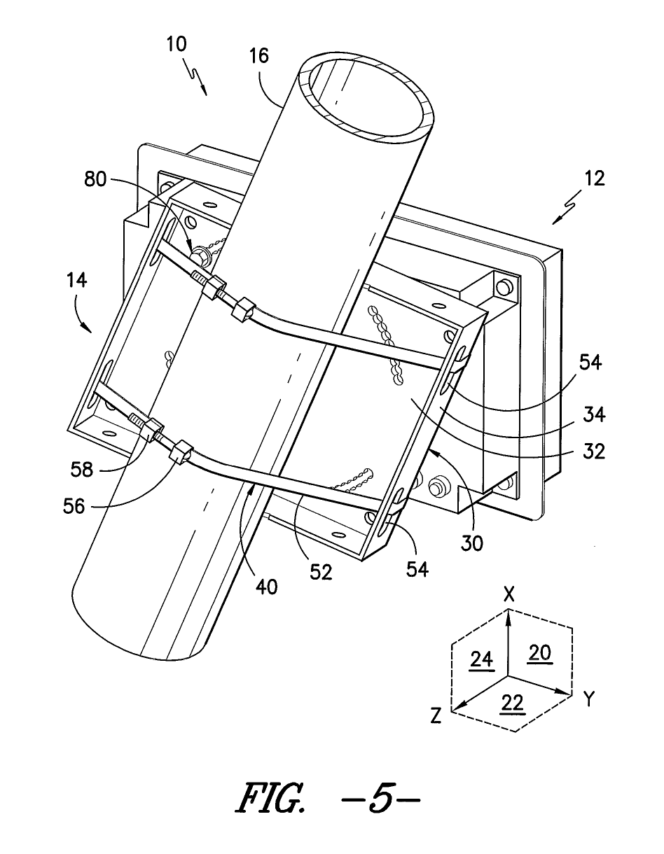

In another exemplary embodiment, as shown in FIGS. 4 and 5, the attachment device 40 of the present disclosure may include an attachment strap 52 or a plurality of attachment straps 52. The attachment strap(s) 52 may be threaded through apertures 54 defined in the mounting bracket 30, such as in the peripheral wall 34 or main surface 32. The attachment straps 52 may further be wrapped around the mount surface 16 and tightened to secure the mounting bracket 30 to the mount surface 16. For example, the attachment device 40 may include a screw 56 and mating aperture 58. The mating aperture 58 may include internal threads configured to mate with external threads on the screw 56, such that as the screw 56 is threadably inserted into the mating aperture 58, the attachment strap 52 may be securably tightened.

It should be understood that the attachment device 40 of the present disclosure is not limited to the attachment bars 42 or attachment straps 52 as discussed above. For example, the attachment bars 42 may utilize any suitable hardware, and are not limited to nuts 46 and bolts 48, for securing the mounting bracket 30 to the mount surface 16. Further, the attachment straps 52 may utilize any suitable hardware, and are not limited to screws 56 and mating apertures 58, for securing the mounting bracket 30 to the mount surface 16. Further, the attachment device 40 of the present disclosure may be any device suitable to secure the mounting bracket 30 to the mount surface 16. For example, in some embodiments, such as when the mount surface 16 is a wall, the attachment device 40 may simply include a nut and bolt or plurality of nuts and bolts, or another attachment mechanism, to bolt or fasten the mounting bracket 30 to the mount surface 16.

In some embodiments, the mounting bracket 30 may be oriented in at least one plane. For example, before, during, or after securing the mounting bracket 30 on the mount surface 16, the mounting bracket 30 may be leveled in any of the X-Y plane 20, the Y-Z plane 22, or the X-Z plane 24. In exemplary embodiments, the mounting bracket 30 may be leveled in the X-Y plane 20. To accomplish orienting the mounting bracket 30, the installer may, for example, adjust the attachment devices 40, or adjust the fit of the mounting bracket 30 against the mount surface 16.

The installation device 14 of the present disclosure may further include a mounting device 60. The mounting device 60 may be configured to mount the telemetry device 12 to the mounting bracket 30. For example, the mounting device 60 of the present disclosure may include a mounting plate 62 and a mating aperture 64. The mounting plate 62 may be associated with one of the mounting bracket 30 or the telemetry device 12, and the mating aperture 64 may be associated with the other of the mounting bracket 30 or the telemetry device 12. For example, in an exemplary embodiment as shown in FIGS. 1 through 5, the mounting plate 62 may be attached to the telemetry device 12, and the mating aperture 64 may be defined in the mounting bracket 30, such as in the main surface 32 of the mounting bracket 30. Alternatively, however, the mounting plate 62 may be attached to the mounting bracket 30, such as to the main surface 32 of the mounting bracket 30, and the mating aperture 64 may be defined in the telemetry device 12.

As discussed above, the mounting plate 62 may be associated with one of the mounting bracket 30 or the telemetry device 12. Further, the mounting plate 62 may be generally spaced from the mounting bracket 30 or telemetry device 12 with which it is associated. For example, the mounting plate 62 may be attached to the mounting bracket 30 or telemetry device 12, such as with a nut 66 and bolt (not shown). A spacer 68 may be disposed between the mounting plate 62 and the mounting bracket 30 or telemetry device 12, providing a space between the mounting plate 62 and the mounting bracket 30 or telemetry device 12. In exemplary embodiments, the spacer 68 may have a perimeter smaller than the perimeter of the mounting plate 62. However, alternatively, the spacer 68 may have a perimeter equal to or greater than the perimeter of the mounting plate 62. The spacing between the mounting plate 62 and the mounting bracket 30 or telemetry device 12 may allow the mounting plate 62 to engage the mating aperture 64.

The mating aperture 64 may generally be configured to accept and capture the mounting plate 62, such that the telemetry device 12 may be mounted to the mounting bracket 30. For example, in one exemplary embodiment as shown in FIGS. 1, 2, 4, and 5, the mating aperture 64 may include a first portion 70 configured to accept the mounting plate 62 and a second portion 72 configured to capture the mounting plate 62. For example, the first portion 70 of the mating groove 64 may have a perimeter approximately equal to or greater than the perimeter of the mounting plate 62, while the second portion 72 of the mating aperture 64 may have a perimeter smaller than the perimeter of the mounting plate 62. Alternatively, however, the first portion 70 may have a perimeter smaller than the perimeter of the mounting plate 62, and/or the second portion 72 may have a perimeter approximately equal to or greater than the perimeter of the mounting plate 62. To mount the telemetry device 12 to the mounting bracket 30, the mounting plate 62 may be placed through the first portion 70 of the mating aperture 64. The mounting plate 62 may then be directed from the first portion 70 to the smaller second portion 72, which may capture the mounting plate 62.

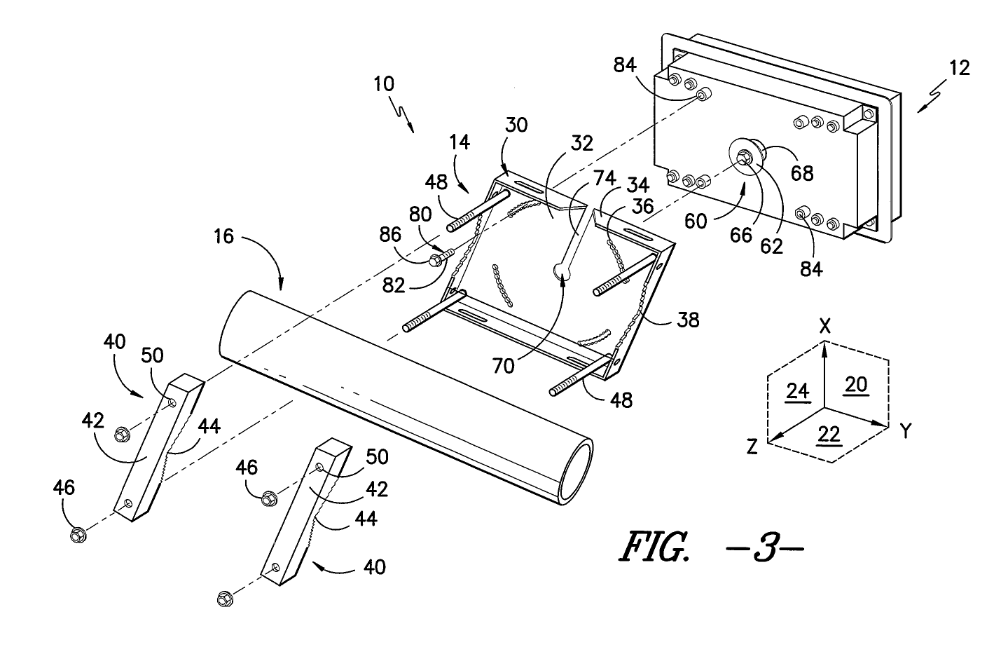

Alternatively, as shown in FIG. 3, a mating aperture 64 in accordance with the present subject matter may include an inlet portion 74. The mating aperture 64 may have a perimeter generally smaller than, or, alternatively, approximately equal to or greater than, the mounting plate 62. The inlet portion 74 may be configured to accept the mounting plate 62. For example, the inlet portion 74 may extend through the periphery of the mounting bracket 30, such as through the edge of the main surface 32 and, in exemplary embodiments, through the peripheral wall 34, and may allow the mounting plate 62 to enter and engage the mating aperture 64. The inlet portion 74 may, in some embodiments, be fully or partially tapered to accommodate the mounting plate 62.

After the telemetry device 12 is mounted to the mounting bracket 30, the telemetry device 12 may be oriented in at least one plane. For example, the telemetry device 12, after the mounting plate 62 is captured and engaged in the mating aperture 64, may be rotatable with respect to the mounting bracket 30. This rotation may allow the telemetry device 12 to be leveled in, for example, the Y-Z plane 22 or X-Z plane 24. In exemplary embodiments, the telemetry device 12 may be leveled in the Y-Z plane 22. To accomplish orienting the telemetry device 12, the installer may, after mounting the telemetry device 12, rotate the telemetry device 12 with respect to the mounting bracket 30 to level the telemetry device 12.

The installation device 14 of the present disclosure may, in exemplary embodiments, include at least one orientation device 80. The orientation device 80 may be associated with any one of the plurality of orientation apertures 36 to secure the telemetry device 12 to the mounting bracket 30 and fix the orientation of the telemetry device 12. For example, the orientation device 80 may include a pin 82 and a mating aperture 84. Further, the orientation device 80 may include more than one pin 82 and/or more than one mating aperture 84. For example, as shown in FIGS. 1 through 5, the orientation device 80 in an exemplary embodiment may include a pin 82 and four mating apertures 84. The mating apertures 84 may, in general, be defined in or on the telemetry device 12. Further, the mating apertures 84 may be configured to accept the pin or pins 82. For example, in one embodiment, the mating apertures 84 may include internal threads configured to mate with external threads on the pin 82, such that the pin 82 may be threadably inserted into a mating aperture 84. Alternatively, the mating apertures 84 may have relatively smooth inner surfaces configured to accept and associate with a relatively smooth external surface of the pin 82. Other various components, such as a nut 86 or, for example, a clamp or other securing apparatus, may be provided to secure the pin 82 in the mating aperture 84.

As mentioned above, the orienting apertures 36 defined in the mating bracket 30 may be provided to secure and fix the orientation of the telemetry device 12. For example, each of the orienting apertures 36 may be configured to accommodate the orienting device 80, such as the pin 82. Thus, to secure and fix the orientation of the telemetry device 12, the pin 82 may be extended through any one of the orienting apertures 36 and further be disposed in a mating aperture 84. Thus, an installer, after orienting the telemetry device 12 as discussed above, may place a pin 82 through a suitable orienting aperture 36 and into a suitable mating aperture 84 to both fix the orientation of the telemetry device 12 and secure the telemetry device to the mounting bracket 30.

The present disclosure is further directed to a method for installing a telemetry device 12 on a mount surface 16. The method may include, for example, securing a mounting bracket 30 to the mount surface 16, as discussed above. In some embodiments, the method of the present disclosure may include orienting the mounting bracket 30 in at least one plane. For example, as discussed above, the mounting bracket 30 may be leveled in any of the X-Y plane 20, the Y-Z plane 22, or X-Z plane 24.

The method may further include mounting the telemetry device 12 to the mounting bracket 30 and orienting the telemetry device 12 in at least one plane, such as by leveling the mounting bracket 30. For example, as discussed above, the telemetry device 12 may be leveled in the Y-Z plane 22 or X-Z plane 24. Further, the method may include fixing the orientation of the telemetry device 12 and securing the telemetry device 12 to the mounting bracket 30, as discussed above. Advantageously, at least the steps of mounting and orienting the telemetry device 12 may be performed independently of each other, thus advantageously allowing an installer to easily and efficiently install a telemetry device 12 on a mount surface 16 and in a proper or desired orientation.

This written description uses examples to disclose the present subject matter, including the best mode, and also to enable any person skilled in the art to practice the present subject matter, including making and using any devices or systems and performing any incorporated methods. While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure and associated claims do not preclude inclusion of such modifications, variations and/or additions to the present subject matter as would be readily apparent to one of ordinary skill in the art.

1. An installation device for installing a telemetry device on a mount surface, comprising:
a mounting bracket, defining a plurality of respective orientation apertures therein;
at least one attachment device, configured to secure said mounting bracket to a mount surface;
a mounting device for mounting a telemetry device to said mounting bracket, said mounting device comprising a mounting plate associated with one of said mounting bracket and the telemetry device, and defining a mating aperture associated with the other of said mounting bracket and the telemetry device; and
at least one orientation device, selectively associated with one of said plurality of orientation apertures, to secure the telemetry device to said mounting bracket and to fix a selected orientation of the telemetry device.

2. The installation device of claim 1, wherein:
said mounting plate is attached to the telemetry device; and
said mating aperture is defined by said mounting bracket.

3. The installation device of claim 1, wherein said mating aperture includes a first portion configured to accept said mounting plate and a second portion configured to capture said mounting plate.

4. The installation device of claim 1, wherein said mating aperture includes an inlet portion configured to accept said mounting plate.

5. The installation device of claim 1, further comprising a plurality of said attachment devices.

6. The installation device of claim 1, wherein said at least one attachment device includes an attachment bar.

7. The installation device of claim 1, wherein said at least one attachment device includes an attachment strap.

8. The installation device of claim 1, wherein said mounting device is configured for the telemetry device to be leveled in a Y-Z plane thereof.

9. A method for installing a telemetry device on a mount surface, comprising:
securing a mounting bracket to a mount surface, the mounting bracket defining a plurality of orientation apertures, with each of the plurality of orientation apertures configured to accommodate an orientation device;
mounting a telemetry device to the mounting bracket;
orienting the telemetry device in at least one plane;
fixing the orientation of the telemetry device; and
securing the telemetry device to the mounting bracket,
wherein the orientation device is associated with any one of the plurality of orientation apertures to secure the telemetry device to the mounting bracket and to fix the orientation of the telemetry device.

10. The method of claim 9, wherein orienting the telemetry device in at least one plane comprises leveling the telemetry device in a Y-Z plane.

11. The method of claim 9, further comprising orienting the mounting bracket in at least one plane.

12. The method of claim 11, wherein orienting the mounting bracket in at least one plane comprises leveling the mounting bracket in an X-Y plane.

13. The method of claim 9, wherein a mounting device is utilized to mount the telemetry device to the mounting bracket, the mounting device comprising a mounting plate associated with one of the mounting bracket or the telemetry device, and a mating aperture associated with the other of the mounting bracket or the telemetry device.

14. The method of claim 13, wherein the mounting plate is attached to the telemetry device, and the mating aperture is defined in the mounting bracket.

15. The method of claim 13, wherein the mating aperture includes a first portion configured to accept the mounting plate and a second portion configured to capture the mounting plate.

16. The method of claim 13, wherein the mating aperture includes an inlet portion configured to accept the mounting plate.

17. An installation system for installing a telemetry device on a mount surface, comprising:
a telemetry device, said telemetry device including a mounting plate attached to and spaced from said telemetry device;
a mounting bracket, said mounting bracket defining a plurality of orientation apertures and a mating aperture, with said mating aperture configured to accept and capture said mounting plate;
a plurality of attachment devices configured to secure said mounting bracket to said mount surface; and
at least one orientation device, wherein said orientation device is associated with any one of said plurality of orientation apertures to secure said telemetry device to said mounting bracket and to fix an orientation of said telemetry device.

18. The installation system of claim 17, wherein said mating aperture includes a first portion configured to accept said mounting plate, and a second portion configured to capture said mounting plate.

19. The installation system of claim 17, wherein said mating aperture includes an inlet portion configured to accept said mounting plate.

20. The installation system of claim 17, wherein said mounting device is configured to allow said telemetry device to be leveled in a Y-Z plane.
